(19) United States
(12) Patent Application Publication
(10) Pub. No.: US 2016/0290842 A1
(43) Pub. Date: Oct. 6, 2016

(54) Method for Operating a Magneto-Inductive Measuring System

(71) Applicant: ENDRESS+HAUSER FLOWTEC AG, Reinach (BL) (CH)

(72) Inventors: Thomas BUDMIGER, Ettingen (CH); Simon STINGELIN, Fehren (CH)

(21) Appl. No.: 15/035,557

(22) PCT Filed: Oct. 17, 2014
(86) PCT No.: PCT/EP2014/072329

§ 371 Date: May 10, 2016

(30) Foreign Application Priority Data
Nov. 11, 2013 (DE) 10 2013 112 373.2

(51) Int. Cl. G01F 1/58

(52) U.S. Cl. CPC G01F 1/58

(57) ABSTRACT

A method for operating a magneto-inductive measuring system, especially a magneto-inductive flow measuring device, in the case of which a magnetic field is produced by a field coil arrangement, through which electrical current flows, wherein the electrical current is a clocked direct current and the field coil arrangement is supplied during a clock interval with a time variable, direct voltage and wherein magnetic energy of the field coil arrangement is determined cyclically or sporadically.

The invention relates to a method for operating a magneto-inductive measuring system, especially a magneto-inductive flow measuring device, as well as a correspondingly adapted apparatus.

The measuring principle applied in such case has a series of advantages, especially independence of measurement results from a series of physical, influencing variables. Especially, the measuring method has found wide application in process technology for measuring flows, especially in pipelines. According to Faraday's law of induction, a voltage is induced in a conductor, which moves in a magnetic field. In the case of flow measurement, the moved conductor is formed by the flowing, measured material. The magnetic field is produced by two field coils, through which electrical current flows. In the case of measuring flow in a measuring tube, two measuring electrodes are arranged on the tube inner wall perpendicular to the field coils. The measuring electrodes sense the voltage induced by the magnetic field when measured substance flows through the tube. The induced voltage is proportional to flow velocity.

Via the known cross sectional area of the tube in the region of the measuring electrodes, volume flow can be calculated from the flow velocity. The measuring of flow velocity in the case of this measuring principle is practically independent of pressure, temperature, density and viscosity of the measured substance. Furthermore, also liquids, which contain solids, e.g. ore slurries or cellulosic pulps, can be measured. The measuring principle can be implemented without disturbing the tube cross section, so that also a simple cleaning with cleaning solutions is possible and the tube is piggable. Furthermore, pressure losses are prevented thereby. Measuring systems, which work with this measuring principle, have no moving parts and require, consequently, little maintenance and care. Emphasized in the case of such measuring systems are high dynamic range, high measurement safety, reproducibility and long term stability.

Such measuring systems are frequently applied in process technology, e.g. in the chemicals industry, and for metering and dosing applications. In many cases, the continuous reliability of the measured value output by the measuring system is of special importance, e.g. in the case of dosing or metering of components into a reactor for the manufacture of chemicals, in order to prevent accidents or environmental damage. Measuring systems of such type are obtainable, for example, from the applicant.

Known in the state of the art are many approaches for improving the reliability, especially the long-term reliability, of the measured value output by the measuring system.

Described in WO 98/20469 A1 is a method and a measuring system, in the case of which the current measurement signal is compared with an expected, stored measurement signal and a remaining life of the sensor determined therefrom. A similar arrangement is known from U.S. Pat. No. 6,654,697 B1, however, for a pressure difference sensor.

Known from DE 101 34 672 C1 is a magneto-inductive flow measuring device, in the case of which the sensor unit has a sensor data storage unit, in which specific characteristic variables of the sensor unit are stored and from which the stored specific characteristic variables are transmittable to an evaluating- and supply unit. Such magneto-inductive flow measuring devices are known, furthermore, e.g. from EP 0 548 439 A1 as well as from U.S. Pat. No. 5,469,746. In the case of the sensor unit, on the one hand, and the evaluating- and supply unit, on the other hand, they are said to be two bodily different units. The essential elements of the sensor unit are, in such case, a measuring tube, the field coils and the measuring electrodes, thus all the systems required for producing and registering the measurement effect. The evaluating and supply unit serves, on the one hand, for supplying the field coils with power and, on the other hand, for evaluating the measurement effect, namely the voltage induced between the measuring electrodes. In order to enable a quantitative evaluation of the voltage induced between the measuring electrodes, thus in order, lastly, to ascertain a value for the flow of the medium flowing through the measuring tube, specific characteristic variables of the sensor unit are required. In the case of the above mentioned magneto-inductive flow measuring devices known from the state of the art, these specific characteristic variables of the sensor unit are furnished in a sensor data storage unit provided in the sensor unit. The sensor data storage unit is said to be connected with the evaluating- and supply unit by means of the field coil supply lines. As a result, it is said to be possible to transmit the stored specific characteristic variables from the sensor data storage unit via the field coil lines to the evaluating- and supply unit. Especially, it is provided that the sensor data storage unit provided in the sensor unit is formed by a non-volatile, electrically overwritable memory, such as an EEPROM.

Known from DE 10 2006 006 152 A1 is a method for controlling and monitoring a measuring system, especially a flow measuring device, in the case of which in cyclic time intervals, besides the measuring of a terminal voltage Uₖ and the terminal current Iₖ, also the ohmic resistance, the inductance, as well as the size of a reference resistance and the magnetization current are measured in cyclically recurring intervals and compared and stored with reference values from a previous calibration measurement. The core concept is said to be, in such case, that for controlling and monitoring the measuring system not only the terminal voltage Uₖ but also the terminal current Iₖ is used. In order to detect changes in the system, elements are cyclically determined, in order, in given cases, to be able to react appropriately. It is, thus, possible, to hold the magnetization current constant by controlling the size of Iₖ. The characterizing data of the individual sizes of the elements are stored during the calibration as reference parameters.

Known from EP 2 074 385 B1 and U.S. Pat. No. 7,750,642 B2 is a flow measuring device, in the case of which a series of nominal data of different parameters are stored in a memory during manufacture. A test circuit is provided, in order to measure a plurality of parameters of the flow measuring device and to produce an output signal as a function of a comparison of the measured values with the stored values.

The comparison is said to be based e.g. on threshold values or time changes. The monitored parameters are said to comprise e.g. the electrical resistance of the exciter coils, the inductance of the exciter coils, the resistance of the measuring electrodes, the analog output, wave form and level of the exciter current, pulse output signal, and digital in- and outputs. The inductance or capacitance is said to be determined based on a test function having a time varying signal. The test function can comprise the operating signal for the exciter coils, as used for normal operation. The exciter coil current is said to be measured via the voltage drop on a sensor resistor connected in series with the exciter coils. Further details are not disclosed.

Known from the state of the art are a plurality from solutions, which are especially intended to improve the long-term reliability of a measuring system of the above mentioned type or provide correction values for the obtained measured values, in order to deliver changes of the sensitivity during the life of such a measuring system. Such changes can arise, for example, from an increased resistance of the field coils, e.g. in the case of operation at changed temperatures or a winding short in the field coil. Above all in the latter case, the generating of an alarm signal is advantageous, in order to indicate a failure leading to corrupted measured values.

The described methods are partially quite complicated and require a more complex construction of the measuring system, especially additional sensor systems or require an adapted process control.

An object of the invention, therefore, is to provide an improved method for monitoring a magneto-inductive measuring system, especially a magneto-inductive flow measuring device.

This object is achieved according to the invention by a method of the above mentioned type, in the case of which a magnetic field is produced by a field coil arrangement, through which electrical current flows, wherein the electrical current is a clocked direct current and the field coil arrangement is supplied during a clock interval with a time variable, direct voltage, wherein, furthermore, the voltage U across the field coil arrangement and the electrical current I flowing through the field coil arrangement are measured and wherein magnetic energy in the field coil arrangement is cyclically or sporadically determined.

The terminology, field coil arrangement, means, in such case, one or more field coils, especially, however, an even number of field coils.

The method of the invention especially also permits detecting or compensating such changes of the sensitivity of such a measuring system, which are not caused by changes or defects in the measuring system, but, instead, are caused by environmental conditions of the location of operation of the measuring system. Such can comprise, for example, external magnetic fields or ferromagnetic materials in the vicinity of the measuring system. Changes of the sensitivity of such a measuring system lead unavoidably to corresponding measurement errors.

By measuring the magnetic energy according to the method of the invention, both device-related deviations as well as also environmentally related deviations from the conditions, for which the measuring system was calibrated, can be easily qualitatively and quantitatively detected and determined.

Advantageous embodiments of the method are subject matter of the dependent claims.

For determining magnetic energy, the rise time tᵣᵢₛₑ of the electrical current is ascertained, wherein tᵣᵢₛₑ is the duration, which the electrical current requires until a coil of the field coil arrangement, or the field coil arrangement, is in steady state operation.

The determined magnetic energy of the field coil arrangement has preferably the following dependence: E˜I². The measured electrical current level is thus taken into consideration in determining the magnetic energy of the field coil arrangement.

The determined magnetic energy of the field coil arrangement has additionally the following dependence: E=K*tᵣᵢₛₑ*I²·K, in such case, is a constant. In determining the magnetic energy, thus, supplementally to the measured electrical current level, also the rise time is taken into consideration. The constant K has the following proportionality:

$$K \sim \frac{0.5}{ln [ ( {U}_{0} + {I}_{0} * R ) / ( {U}_{0} - {I}_{0} * R ) ]} ,$$

wherein R is the ohmic resistance of the field coil arrangement, U₀ the voltage across the field coil arrangement, and I₀ the electrical current through the coil in steady state operation.

The determining of the magnetic energy of the field coil arrangement can especially occur according to the following formula:

$$E = 0.5 * ( \frac{{t}_{rise} * R}{ln ( \frac{{U}_{0} + {I}_{0} * R}{{U}_{0} - {I}_{0} * R} )} ) * {I}^{2}$$

wherein R is the ohmic resistance of the field coil arrangement,

U₀ the voltage across the field coil arrangement, and

tᵣᵢₛₑ and I₀ concern the electrical current through the coil in steady state operation.

Since the field coils are supplied during a clock interval with a time variable, direct voltage, the magnetic field can reach its constant magnetic field end value at an earlier point in time than it otherwise would. Especially, it is advantageous, when the time variable, direct voltage includes a voltage overshoot, and the duration tₛₕₒₒₜ of the voltage overshoot is registered

In order to make the measuring insensitive to influences of multiphase materials, inhomogeneities in the liquid or low conductivity of the liquid and in order to assure a stable zero-point for the measuring, the magnetic field is preferably produced by a clocked direct current of alternating polarity.

In an advantageous embodiment of the method of the invention, the rise time tᵣᵢₛₑ is determined from the sum of the duration tᵣₑᵥ of a reverse current, the duration t_{fwd} of a forwards current and the duration t_{drop} of the transition of the forwards current to a steady value, especially the duration tᵣₑᵥ of the reverse current is determined by linear interpolation from the time sequence of the measured values registered for the reverse current, the duration t_{fwd} of the forwards current is determined from the difference of the rise time tᵣᵢₛₑ and the duration of the voltage overshoot tₛₕₒₒₜ and the fall-off time t_{drop} are determined from the time sequence of the measured values registered for the forwards current.

For a simple evaluation, it is advantageous, when the voltage U₀ across the field coil is formed from the average values of the registered voltage during the rise time tᵣᵢₛₑ of the electrical current, especially according to the formula

U₀=(Uᵣₑᵥ*tᵣₑᵥ+U_{fwd}*(t_{fwd}+t_{drop}))/tᵣᵢₛₑ

wherein Uᵣₑᵥ is the voltage across the field coil during tᵣₑᵥ and U_{fwd} the voltage across the field coil during the durations t_{fwd} and t_{drop}.

The ohmic resistance R of the field coil is determined according to the formula R=Uₛₜₐₜ/I₀, wherein Uₛₜₐₜ is the terminal voltage across the field coil in the steady state.

For efficient registering the inductance, it is helpful to have the registration rate of the values for voltage and electrical current amount to at least, for instance, 10 kHz. Higher sampling rates do, indeed, improve the accuracy, require, however, more powerful electronics.

The object is, furthermore, achieved by a magneto-inductive measuring system, especially a magneto-inductive flow measuring device, for performing the method, comprising a direct voltage source containing a clock signal generator, wherein the direct voltage source is connected with the terminals of a field coil arrangement and between the direct voltage source and the field coil arrangement a measuring resistor Rᵢ is connected in series with the field coil arrangement, and wherein a first voltage measurement system is connected with the terminals of the field coil arrangement for measuring voltage U across the field coil arrangement, and wherein another voltage measurement system is connected with the measuring resistor Rᵢ for measuring voltage drop across the measuring resistor Rᵢ for registering the electrical current I through the field coil arrangement, and wherein each of the voltage measurement systems is connected with an analog-digital converter for digitizing the registered voltage values, wherein, furthermore, the analog-digital converter is connected with an evaluating circuit, wherein the direct voltage source is connected with the evaluating circuit for transmission of the clocked signal, and the evaluating circuit is connected, furthermore, with a time reference for registering duration of voltage states for determining inductance according to the method.

An example of the invention will now be explained based on the appended drawing. The figures of the drawing show as follows:

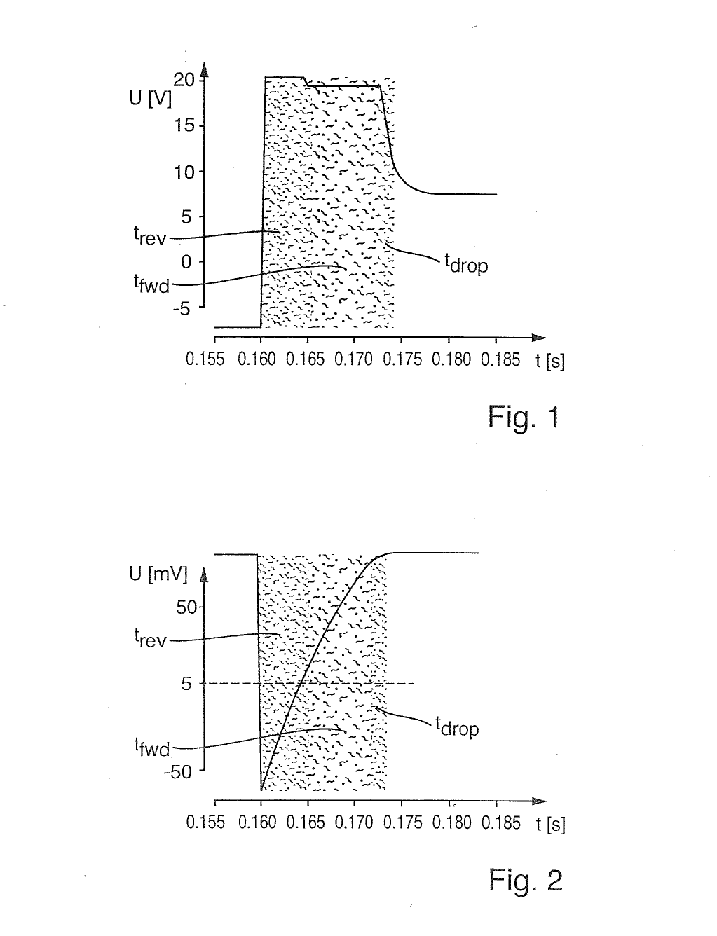

FIG. 1 a graph of an example of voltage across a field coil as a function of time;

FIG. 2 a graph of an example of exciter current through a field coil in the form of voltage drop across an electrical current measuring resistor as a function of time; and

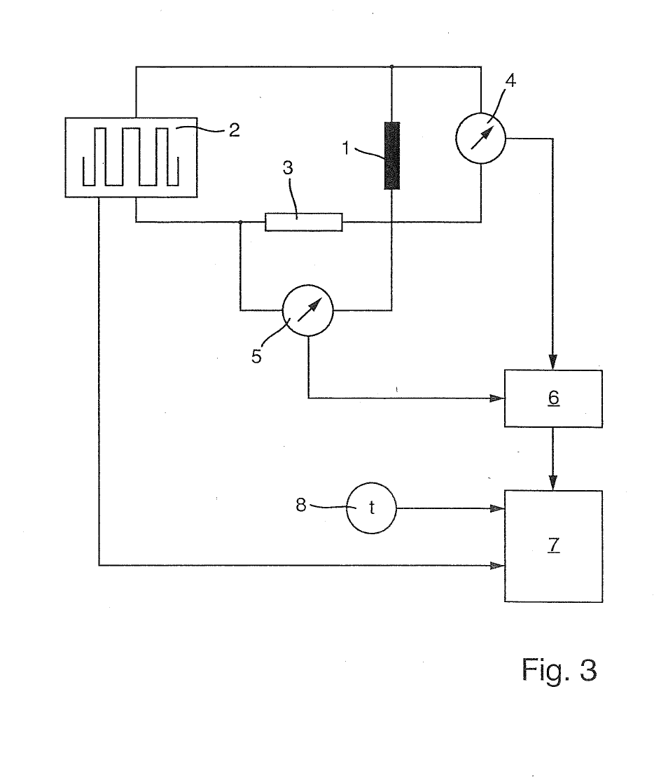

FIG. 3 a schematic representation of an example of an apparatus for performing the method.

The method of the invention can especially advantageously be implemented in the case of a magneto-inductive measuring system, especially a magneto-inductive flow measuring device, in the case of which the field coil arrangement 1 is excited with a clocked direct current I of alternating polarity. The field coil arrangement 1 advantageously includes a pair of field coils 1 for producing the magnetic field. The field coils 1 are supplied during a clock interval with a time variable, direct voltage U, in order to achieve a rapid reaching of the constant electrical current end value and therewith of the magnetic field.

Known from U.S. Pat. No. 3,634,733 A is a circuit for exciting an inductive load. The circuit contains two electrical current sources of different output voltages, wherein a switching amplifier arrangement connects the inductive load, first of all, with the electrical current source of higher voltage for a predetermined time span, after whose expiration a trigger circuit effects the switching to an electrical current source of lower output voltage, so that the inductive load is operated, first, for a predetermined duration with a maximum electrical current, and then is supplied with an electrical current source of lower voltage.

Known from U.S. Pat. No. 4,144,751 A is a rectangle generator circuit for exciting, especially for providing a field coil of an electromagnetic flow measuring system with a polarity alternation of the electrical current. During the transition time after the switching event, a higher voltage is used by the electrical current supply, in order to lessen the rise and fall times, and a lower voltage is used during a steady state of the exciter current for energy saving. A switching amplifier is used, in order to provide the higher voltage, while a diode arranged in the blocking direction is used, in order directly to provide the lower voltage, as soon as the exciter current has reached a steady value. A voltage comparator circuit is used, in order to compare the voltage produced by the exciter current with a reference voltage, in order to produce an output signal for switching the switching amplifier between its on and off states during the transition time and the steady state operation.

Known from EP 0 969 268 A1 is a method for control of the coil current of magneto-inductive flow transducers. Basic idea of the two described variants of the method is to calculate in advance, according to a plan, the voltage required for producing the coil current in each half period and the course of the voltage as a function of time based on the course of the coil current arising in the preceding half period from after the maximum of the coil current until the constant electrical current end value is achieved. An advantage of the method is that it achieves that the rise of the magnetic field follows exactly the rise of the coil current, such as happens in the case of coil arrangements without coil cores and/or pole shoes. Thus, the magnetic field achieves its constant magnetic field end value at an earlier point in time.

The magneto-inductive flow measuring device shown schematically in FIG. 3 is adapted for performing the method and includes a direct voltage source 2 containing a clock signal generator. The direct voltage source 2 is connected with the terminals of a field coil arrangement 1. Inserted between the direct voltage source 2 and the field coil arrangement 1 in series with the field coil arrangement 1 is a measuring resistor (Rᵢ) 3. A first voltage measurement system 4 is connected with the terminals of the field coil arrangement 1 for measuring voltage U across the field coil arrangement 1. Another voltage measurement system 5 is connected with the measuring resistor Rᵢ 3 for measuring voltage drop across the measuring resistor Rᵢ 3 for registering the electrical current I through the field coil arrangement 1. Each of the voltage measurement systems 4, 5 is connected with an analog-digital converter 6 for digitizing the registered voltage values. Furthermore, the analog-digital converter 6 is connected with an evaluating circuit 7. The evaluating circuit 7 is connected with the direct voltage source 2 for transmission of the clocked signal, and the evaluating circuit 7 is, furthermore, connected with a time reference 8 for registering duration of the voltage states for determining inductance according to the method of the invention.

In the case of operation of such a measuring system, according to the invention, the voltage U across the field coil 1 is measured by the first voltage measurement system 4. The electrical current I flowing through the field coil 1 is measured by measuring the voltage drop across the electrical current measuring resistor 3 Ri with the second voltage measurement system 5. These measurements occur cyclically or sporadically, in order to determine the inductance of the field coil 1. The voltage values of the voltage measurement systems 4, 5 are digitized by the analog-digital converter 6, advantageously with a sampling rate of at least, for instance, 10 kHz.

The voltage curve across the terminals of the field coil 1 is shown in FIG. 1. The voltage curve across the electrical current measuring resistor Rᵢ 3 and therewith the curve of the electrical current through the field coil 1 is shown in FIG. 2. Plotted on the ordinate is the voltage U, and, on the abscissa, the time t.

The field coils 1 are supplied during a clock interval with a time variable, direct voltage. The time variable, direct voltage includes a voltage overshoot and the duration tₛₕₒₒₜ of the voltage overshoot is registered. The start of a clock interval is determined through the polarity change of the voltage across the field coil arrangement 1. This polarity change is registered from a signal of the direct voltage source 2 to the evaluating circuit 7. The clock interval beginning can, however, also be won from the signal of the first voltage measurement system 4 by measuring the voltage U across the field coil arrangement 1.

The rise time tᵣᵢₛₑ of the exciter current I is determined from the sum of the duration tᵣₑᵥ of the reverse current, the duration t_{fwd} of the forwards current and the duration t_{drop} of the transition of the forwards current to a steady value. The voltage jump of the direct voltage at the beginning of the clock interval induces a reverse current in the field coil 1. The name, reverse current, results from the fact that the induced reverse current is directed counter to the polarity of the applied direct voltage. The reverse current is easily detectable via the second voltage measurement system 5 and is indicated by a negative voltage value. The duration tᵣₑᵥ of the reverse current is the time until the electrical current achieves the value 0 starting from the negative beginning value. The further rise of the electrical current I in the same direction as the polarity of the applied direct voltage occurs during the duration t_{fwd}. The end of the duration t_{fwd} is detected by the steep voltage decrease across the field coil 1 at the end of the output of the superelevated direct voltage across the first voltage measurement system 4.

The length of the duration t_{fwd} can be ascertained, consequently, from the duration tₛₕₒₒₜ of the voltage overshoot minus the duration tᵣₑᵥ of the reverse current. The duration t_{drop} of the transition of the forwards current to a steady value begins at the end of the output of the superelevated direct voltage and is detected via the first voltage measurement system 4.

For increased accuracy, it is advantageous to determine the duration tᵣₑᵥ of the reverse current from the time sequence of the measured values registered for the reverse current by the second voltage measurement system 5 by linear interpolation of the registered individual values.

The signal of the first voltage measurement system 4 gives the voltage across the field coil 1. The determining of a value for the voltage U₀ across the field coil 1 is made from the average values of the registered voltages during the rise time tᵣᵢₛₑ of the electrical current according to the formula U₀=(Uᵣₑᵥ*tᵣₑᵥ+U_{fwd}*(t_{fwd}+t_{drop}))/tᵣᵢₛₑ, wherein Uᵣₑᵥ is the voltage across the field coil during tᵣₑᵥ and U_{fwd} the voltage across the field coil during the durations t_{fwd} and t_{drop}.

The ohmic resistance R of the field coil 1 is determined according to the formula R=Uₛₜₐₜ/I₀, wherein Uₛₜₐₜ is the terminal voltage across the field coil 1 in steady state operation and I₀ the electrical current through the coil in steady state operation.

Then, the magnetic energy can be determined from the rise time tᵣᵢₛₑ according to the formula

E=0.5×((tᵣᵢₛₑ×R)/ln((U₀+I₀×R)/(U₀−I₀×R)))×I².

Changes of the value of the magnetic energy of the field coil arrangement, respectively of the field coil arrangement 1, compared with the value at calibration or previous values, which were ascertained such as earlier described, can be used by the evaluating circuit 7 for correction of the measured value or for output of a warning signal, in order to prevent the application of incorrect measured values in the process control.

For an exact registering of data as a function of time, the evaluating circuit 7 is connected with a time reference 8. Such a time reference 8 can also be integrated into the evaluating circuit 7, although here, for clarity, it is shown as a separate element.

1-14. (canceled)

15. A method for operating a magneto-inductive measuring system, for a magneto-inductive flow measuring device, comprising the steps of:
producing a magnetic field by a field coil arrangement, through which electrical current flows, the electrical current is a clocked direct current and the field coil arrangement is supplied during a clock interval with a time variable, direct voltage;
measuring the voltage across the field coil arrangement and the electrical current flowing through the field coil arrangement; and
determining the magnetic energy in the field coil arrangement cyclically or sporadically.

16. The method as claimed in claim 15, wherein:
rise time tᵣᵢₛₑ the electrical current is ascertained and the magnetic energy determined based on the ascertained rise time tᵣᵢₛₑ, wherein tᵣᵢₛₑ is the duration, which the electrical current requires until a coil is in steady state operation.

17. The method as claimed in claim 15, wherein:
the determined magnetic energy of the field coil arrangement has the following dependence:
E˜I²

18. The method as claimed in claim 17, wherein:
the determined magnetic energy of the field coil arrangement has the following dependence:
E=K*tᵣᵢₛₑ*I²

19. The method as claimed in claim 18, wherein:
K has the following dependence:
$$K \sim \frac{0.5}{ln [ ( {U}_{0} + {I}_{0} * R ) / ( {U}_{0} - {I}_{0} * R ) ]}$$
wherein R is the ohmic resistance of the field coil arrangement, U₀ the voltage across the field coil arrangement, and I₀ the electrical current through the coil in steady state operation.

20. The method as claimed in claim 15, wherein:
said time variable, direct voltage includes a voltage overshoot, and the duration tₛₕₒₒₜ of the voltage overshoot is registered.

21. The method as claimed in claim 15, wherein:
the electrical current is a clocked direct current of alternating polarity.

22. The method as claimed in claim 15, wherein:
said rise time tᵣᵢₛₑ is determined from the sum of the duration tᵣₑᵥ of a reverse current, the duration t_{fwd} of a forwards current and the duration t_{drop} of transition of the forwards current to a steady value.

23. The method as claimed in claim 22, wherein:
the duration tᵣₑᵥ of the reverse current is determined by linear interpolation from the time sequence of the measured values registered for the reverse current, the duration t_{fwd} of the forwards current from the difference of the rise time tᵣᵢₛₑ and the duration of the voltage overshoot tₛₕₒₒₜ and the fall-off time t_{drop} from the time sequence of the measured values registered for the forwards current.

24. The method as claimed in claim 19, wherein:
said voltage U₀ across the coil arrangement is formed from the average values of the registered voltage during the rise time tᵣᵢₛₑ of the electrical current.

25. The method as claimed in claim 24, wherein:
said voltage U₀ is determined according to the formula
U₀=(Uᵣₑᵥ×tᵣₑᵥ+U_{fwd}×(t_{fwd}+t_{drop}))/tᵣᵢₛₑ
wherein Uᵣₑᵥ is the voltage across the field coil arrangement during tᵣₑᵥ and U_{fwd} the voltage across the field coil during the durations t_{fwd} and t_{drop}.

26. The method as claimed in claim 19, wherein:
said ohmic resistance R of the field coil arrangement is determined according to the formula R=Uₛₜₐₜ/I₀, wherein Uₛₜₐₜ is the terminal voltage across the field coil arrangement in steady state operation.

27. The method as claimed in claim 15, wherein:
the registration rate of the values for voltage and electrical current amounts to at least 10 kHz.

28. A magneto-inductive flow measuring device for magneto-inductive flow measuring system, comprising:
a field coil arrangement;
a first voltage measuring system;
an analog-digital converter;
a direct voltage source containing a clock signal generator, said direct voltage source is connected with the terminals of said field coil arrangement and between said direct voltage source and said field coil arrangement;
a measuring resistor connected in series with said field coil arrangement, said first voltage measuring system is connected with the terminals of said field coil arrangement for measuring voltage across said field coil arrangement;
another voltage measuring system connected with said measuring resistor for measuring voltage drop across said measuring resistor for registering electrical current through said field coil arrangement,
an evaluating circuit; and
a time reference, wherein:
each of said voltage measuring systems is connected with said analog-digital converter or digitizing registered voltage values;
said analog-digital converter is connected with said evaluating circuit; and
said direct voltage source is connected with said evaluating circuit for transmission of the clocked signal, and said evaluating circuit is connected with said time reference for registering duration of voltage states for determining magnetic energy.
